(19) United States
(12) Patent Application Publication
(10) Pub. No.: US 2010/0033471 A1
(43) Pub. Date: Feb. 11, 2010

(54) DISPLAY DRIVING CIRCUIT AND DRIVING METHOD THEREOF

(76) Inventor: Chun-Han Liu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/346,902

(22) Filed: Dec. 31, 2008

(30) Foreign Application Priority Data
Aug. 8, 2008 (TW) 097130342

(51) Int. Cl. G09G 5/00; G09G 3/36

(52) U.S. Cl. 345/212; 345/87

(57) ABSTRACT

A display driving circuit includes a power detector, a plurality of control units and a plurality of buffer amplifiers. The power detector outputs a control signal according to a voltage level of a supply voltage. Each control unit determines the control unit to output either auxiliary display data or original display data according to the control signal. The plurality of buffer amplifiers buffer and transfer the auxiliary display data or original display data outputted from the plurality of control units to a plurality of data lines.

### BACKGROUND OF THE INVENTION

1. Field of the Invention

The present invention relates to a display driving circuit, and more particularly, to a display driving circuit that determines to output either auxiliary display data or original display data according to a voltage level of a supply voltage, and a driving method thereof.

2. Description of the Prior Art

When a liquid crystal display (LCD) powers off, a supply voltage of a timing controller of the LCD is removed, and an output voltage of each channel of a data driving circuit is therefore destabilized, causing a “power-off noise” phenomenon. Please refer to FIG. 1, FIG. 1 is a diagram illustrating outputting voltages of two channels of the data driving circuit when a prior art LCD powers off. As shown in FIG. 1, the output voltages of the channels Ch1 and Ch2 after the LCD powers off are irregular (i.e., waveforms between the channels Ch1 and Ch2 are different), causing non-uniformity of the image. In addition, due to different lengths of the current paths and process variation between data driving circuits, the above-mentioned “non-uniformity of the image” (power-off noise) is more serious when comparing two display regions corresponding to different data driving circuits.

### SUMMARY OF THE INVENTION

It is therefore an objective of the present invention to provide a display driving circuit that determines to output either auxiliary display data or original display data according to a voltage level of a supply voltage and a driving method thereof, to solve the above-mentioned “power-off noise” phenomenon.

According to one embodiment of the present invention, a display driving circuit comprises a power detector, a plurality of control units and a plurality of buffer amplifiers. The power detector outputs a control signal according to a voltage level of a supply voltage. Each control unit determines to output either auxiliary display data or original display data according to the control signal. The plurality of buffer amplifiers respectively buffer and transfer the auxiliary display data or original display data outputted from the plurality of control units to a plurality of data lines.

A corresponding display driving method comprises: outputting a control signal according to a voltage level of a supply voltage; determining a control unit to output either auxiliary display data or original display data according to the control signal; and buffering and transferring the auxiliary display data or original display data to a plurality of data lines of a display.

According to the display driving circuit and the display driving method of the present invention, when the display powers off, the control units output the auxiliary display data, where the auxiliary display data can be display data having a predetermined gray value. Therefore, the display will show a uniform image, avoiding the “power-off noise” phenomenon.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating outputting voltages of two channels of the data driving circuit when a prior art LCD powers off.

FIG. 2 is a diagram illustrating a display driving circuit according to one embodiment of the present invention.

FIG. 3 illustrates timing diagrams of a supply voltage and a control signal shown in FIG. 2.

FIG. 4 is a diagram illustrating output signals outputted by the display driving circuit when the predetermined gray value equals 0.

FIG. 5 is a diagram illustrating output signals outputted by the display driving circuit when the predetermined gray value equals 255.

FIG. 6 is a diagram illustrating output signals outputted by the display driving circuit when the predetermined gray value corresponds to a common voltage.

### DETAILED DESCRIPTION

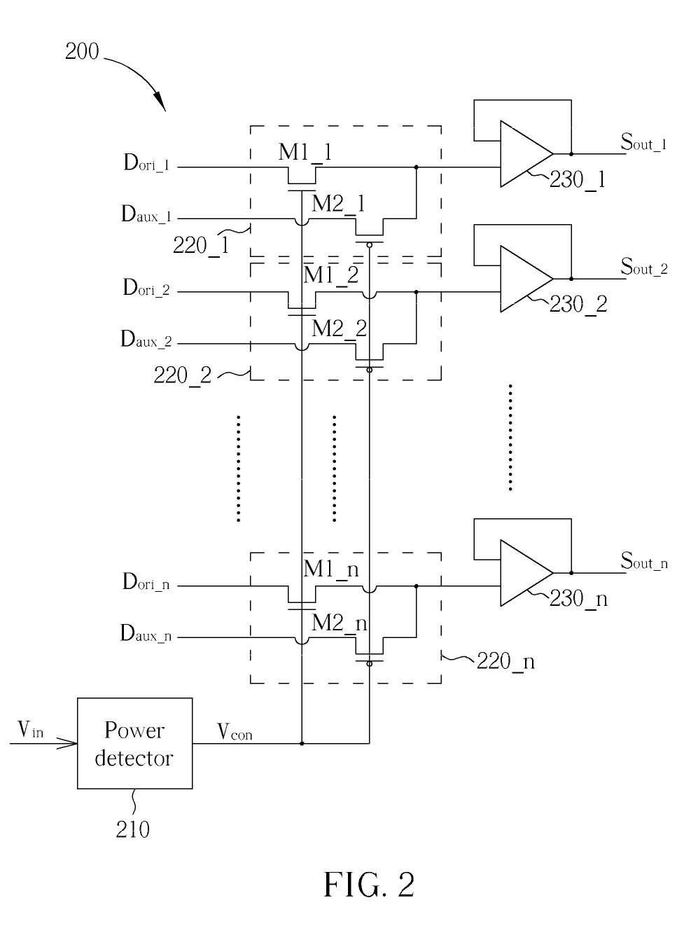

Please refer to FIG. 2. FIG. 2 is a diagram illustrating a display driving circuit according to one embodiment of the present invention. As shown in FIG. 2, the display driving circuit 200 includes a power detector 210, a plurality of control units 220_1-220_{—}n and a plurality of buffer amplifiers 230_1-230_{—}n, where each control unit 220_1-220_{—}n includes an NMOS (N-type Metal Oxide Semiconductor) M1 and a PMOS (P-type Metal Oxide Semiconductor) M2, and output nodes of the buffer amplifiers 230_1-230_{—}n are connected to a plurality of data lines of a display panel. In addition, in one embodiment of the present invention, the display driving circuit 200 is applied to an LCD, however, this is not meant to be a limitation of the display driving circuit 200.

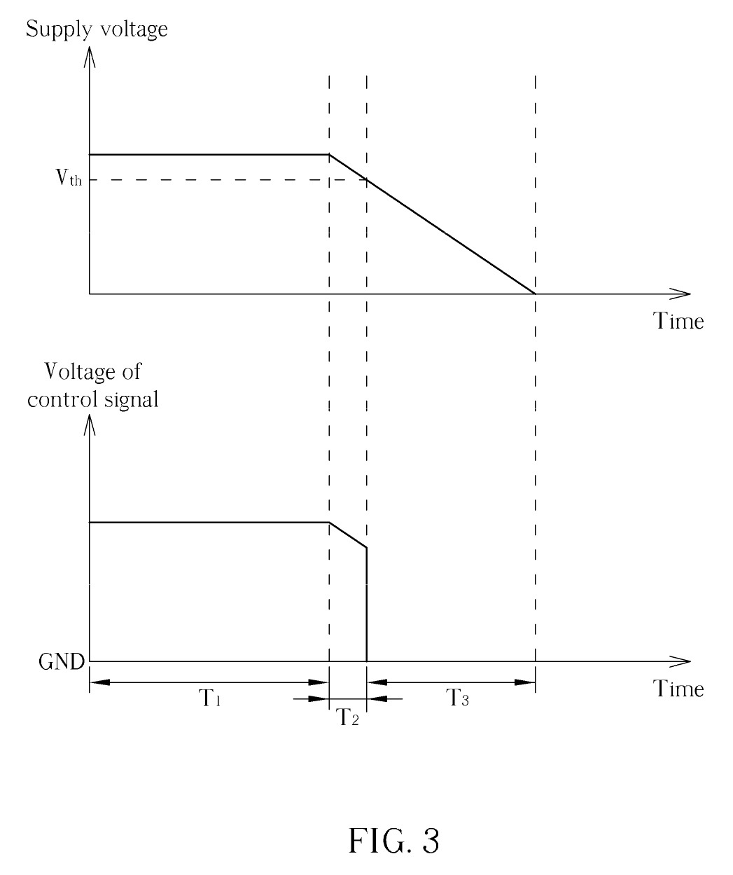

Please refer to FIG. 2 and FIG. 3 together, FIG. 3 illustrates timing diagrams of the supply voltage Vᵢₙ and control signal V_{con} shown in FIG. 2. In the operations of the display driving circuit 200, at time T₁ the display is working; that is, the supply voltage Vᵢₙ of the display is a predetermined value, and the control signal V_{con} outputted from the power detector 210 corresponds to a first logic level. In this embodiment, the first logic level is a high voltage level, and the NMOS M1_1-M1_{—}n of the control units 220_1-220_{—}n are turned on, and the PMOS M2_1-M2_{—}n are turned off. Therefore, the control units 220_1-220_{—}n respectively output the original display data Dₒᵣᵢ_{_{—}}₁-Dₒᵣᵢ_{_{—}}ₙ according to the control signal V_{con}. Then, the buffer amplifiers 230_1-230_{—}n respectively buffer the original display data Dₒᵣᵢ_{_{—}}₁-Dₒᵣᵢ_{_{—}}ₙ to generate a plurality of output signals Sₒᵤₜ_{_{—}}₁-Sₒᵤₜ_{_{—}}ₙ, and transmit the output signals Sₒᵤₜ_{_{—}}₁-Sₒᵤₜ_{_{—}}ₙ to the data lines of the display panel.

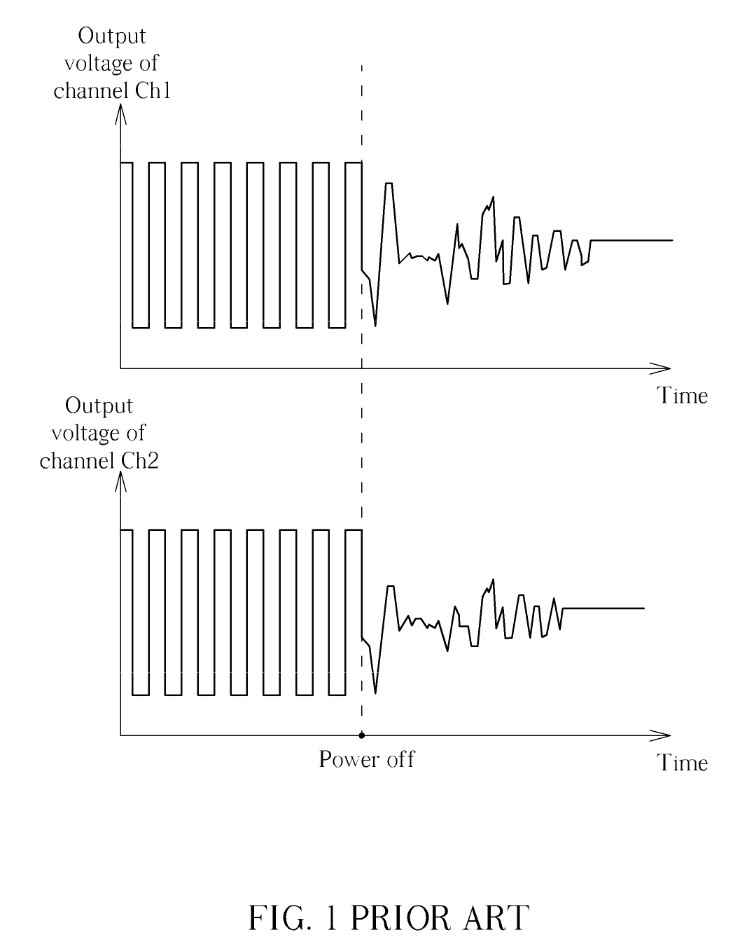

When the display powers off (i.e., at time T₂ shown in FIG. 3), the supply voltage Vᵢₙ starts to gradually decrease, and it is at this time point that the “power-off noise” shown in FIG. 1 occurs. As shown in FIG. 3, when the supply voltage Vᵢₙ drops to a threshold value Vₜₕ, the control signal V_{con} corresponds to a second logic level. In this embodiment, the second logic level is a ground voltage level GND. It is noted that, at time T₂ shown in FIG. 3, the voltage level of the control signal V_{con} decreases as the supply voltage Vᵢₙ decreases. In practice, however, when the voltage level of the supply voltage Vᵢₙ is greater than the threshold voltage Vₜₕ, the voltage level of the control signal V_{con} can remain at the first logic level rather than change. That is, as long as the voltage level of the control signal V_{con} can make the control units 220_1-220_{—}n output the corresponding original display data Dₒᵣᵢ_{_{—}}₁-Dₒᵣᵢ_{_{—}}ₙ.

At time T₃, because the control signal V_{con} corresponds to the second logic level (ground voltage level GND), the NMOS M1_-1-M1₁₃ n of the control units 220_1-220_{—}n are turned off, and the PMOS M2_1-M2_{—}n are turned on. Therefore, the control units 220_1-220_{—}n respectively output the auxiliary display data Dₐᵤₓ_{_{—}}₁-Dₐᵤₓ_{_{—}}₂ according to the control signal V_{con}. Then, the buffer amplifiers 230_1-230_{—}n respectively buffer the auxiliary display data Dₐᵤₓ_{_{—}}₁-Dₐᵤₓ_{_{—}}₂ to generate a plurality of output signals Sₒᵤₜ_{_{—}}₁-Sₒᵤₜ_{_{—}}ₙ, and transmit the output signals Sₒᵤₜ_{_{—}}₁-Sₒᵤₜ_{_{—}}ₙ to the data lines of the display panel.

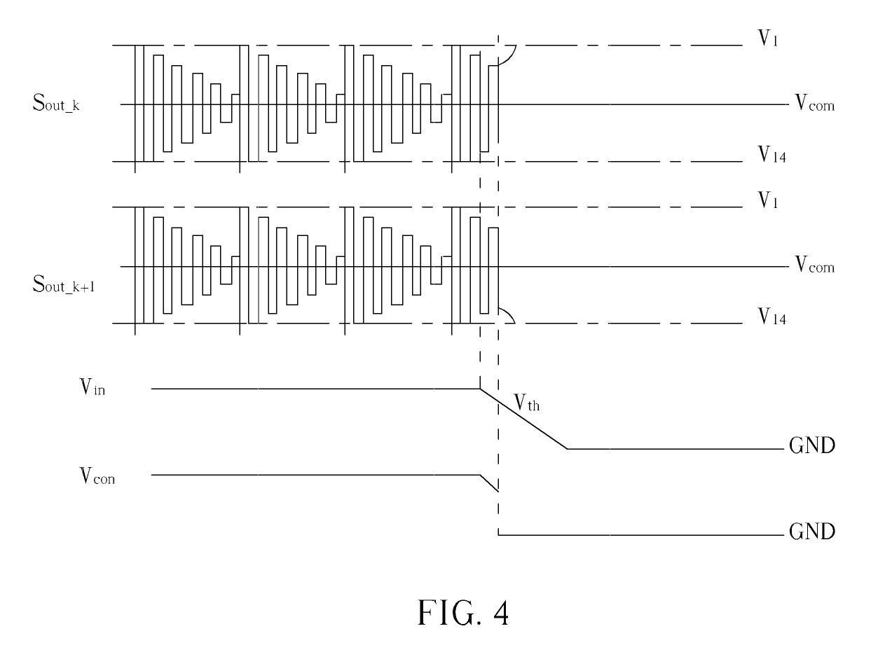

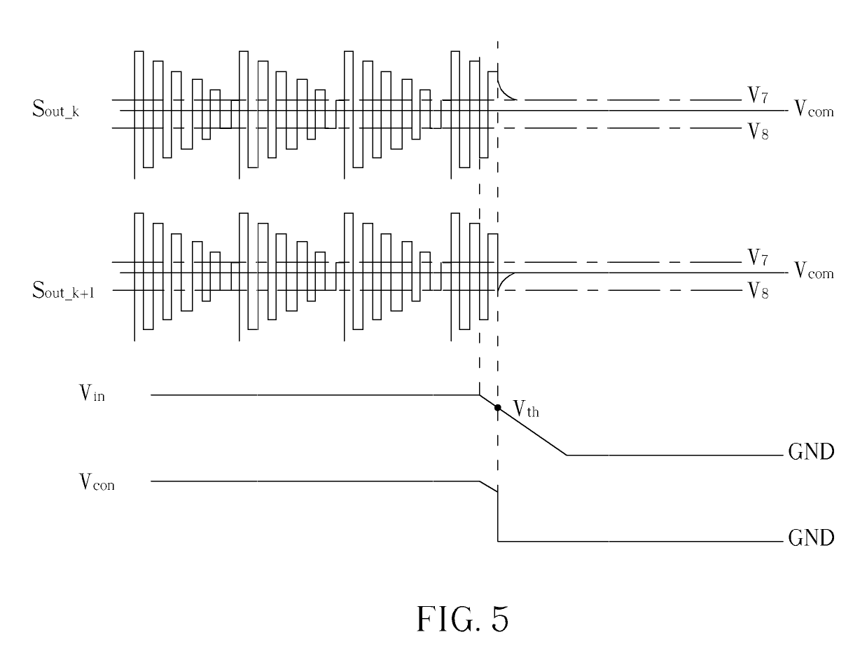

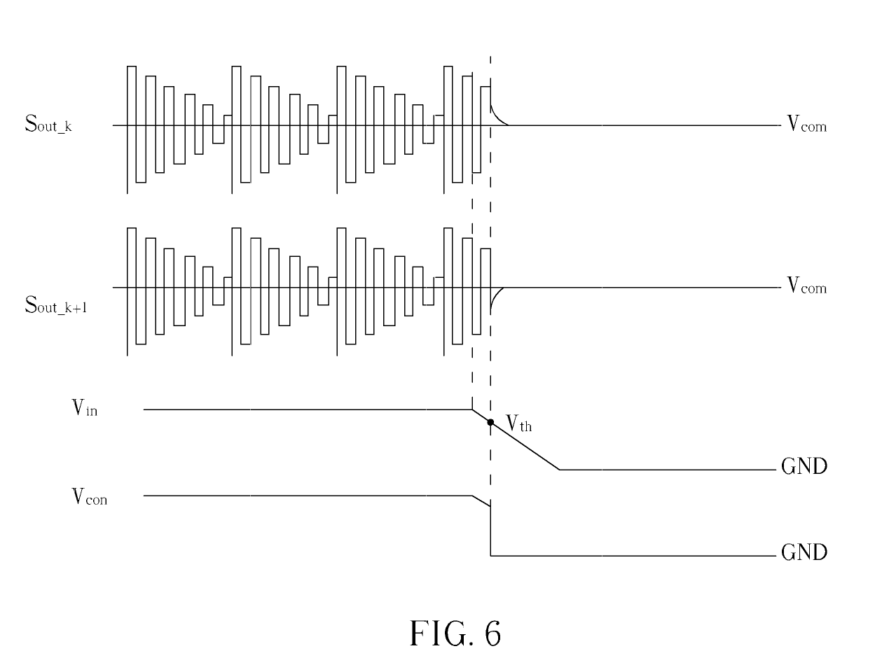

In this embodiment, the auxiliary display data Dₐᵤₓ_{_{—}}₁-Dₐᵤₓ_{_{—}}ₙ are set to be display data having a predetermined gray value, to make the image be uniform when the display powers off. In general, the predetermined gray value is 0 or 255, that is, the image is a black image or a white image when the display powers off. In addition, for convenience of the design, the predetermined gray value can be a gray value corresponding to a common voltage (i.e., the voltage at a common electrode of the display panel). FIGS. 4-6 are diagrams illustrating output signals outputted by the display driving circuit 200 when the predetermined gray value equals to 0, 255, or corresponds to the common voltage. In FIGS. 4-6, V₁-V₁₄ are voltage levels respectively corresponding to specific gray values, V_{com} is the common voltage, and Sₒᵤₜ_{_{—}}ₖ and Sₒᵤₜ_{_{—}}ₖ₊₁ are output signals of two adjacent channels of the display driving circuit 200. Because polarities of two adjacent channels are inverse, in FIG. 4, which illustrates the black image is set when the display powers off, the voltage levels of the output signals Sₒᵤₜ_{_{—}}ₖ and Sₒᵤₜ_{_{—}}ₖ₊₁ are V₁ and V₁₄, respectively. Similarly, in FIG. 5, which illustrates the white image is set when the display powers off, the voltage levels of the output signals Sₒᵤₜ_{_{—}}ₖ and Sₒᵤₜ_{_{—}}ₖ₊₁ are V₇ and V₈, respectively. It is noted that the output signals of the display driving circuit 200 as shown in FIGS. 4-6 are for a normally-white LCD. A person skilled in this art, however, can easy apply the present invention to a normally-black LCD.

It is also noted that the supply voltage Vᵢₙ to be detected by the power detector 210 is not limited to be the power supply of the display, and can also be any device or component related to the power supply of the display; that is, the voltage of the device or component varies with the supply voltage of the power supply of the display. In addition, the control signals V_{con} outputted by the power detector 210, and the circuit structures of the control units 220_1-220_{—}n are for illustrative purposes only. In practice, when the supply voltage of the display drops to the threshold voltage, the power detector 210 can output a control signal to make the control units 220_1-220_{—}n output auxiliary display data immediately according to the control signal when the display powers off to avoid “power-off noise”. These alternative designs all fall within the scope of the present invention.

Briefly summarizing the display driving circuit and the driving method of the present invention, the display driving circuit includes a power detector, a plurality of control units and a plurality of buffer amplifiers. The power detector outputs a control signal according to a voltage level of a supply voltage. Each control unit determines the control unit to output auxiliary display data or original display data according to the control signal. When the display powers off, the plurality of control units output the auxiliary display data, where the auxiliary display data can be display data having a predetermined gray value. Therefore, the display will show a uniform image to prevent the “power-off noise” phenomenon.

Those skilled in the art will readily observe that numerous modifications and alterations of the device and method may be made while retaining the teachings of the invention.

What is claimed is:

1. A display driving circuit, comprising:
a power detector, for outputting a control signal according to a voltage level of a supply voltage; and
a plurality of control units coupled to the power detector, wherein each control unit outputs either an auxiliary display data or an original display data according to the control signal.

2. The display driving circuit of claim 1, further comprising:
a plurality of buffer amplifiers, respectively coupled to the plurality of control units and a plurality of data lines of a display, for respectively buffering and transmitting the auxiliary display data or the original display data to the plurality of data lines.

3. The display driving circuit of claim 1, wherein the auxiliary display data is a display data having a predetermined gray value.

4. The display driving circuit of claim 3, wherein the predetermined gray value is 0 or 255.

5. The display driving circuit of claim 3, wherein the predetermined gray value corresponds to a common voltage.

6. The display driving circuit of claim 1, wherein when the power detector detects the level of the supply voltage to be greater than a threshold value, the control signal corresponds to a first logic level; when the power detector detects the level of the supply voltage to be not greater than the threshold value, the control signal corresponds to a second logic level; when the control signal corresponds to the second logic level, the control units respectively output the auxiliary display data according to the control signal; and when the control signal corresponds to the first logic level, the control units respectively output the original display data according to the control signal.

7. The display driving circuit of claim 1, being implemented in a liquid crystal display (LCD).

8. A display driving method, comprising:
outputting a control signal according to a voltage level of a supply voltage;
and
determining to output either an auxiliary display data or an original display data according to the control signal.

9. The display driving method of claim 8, further comprising:
buffering and transmitting the auxiliary display data or the original display data to a display.

10. The display driving method of claim 8, wherein the auxiliary display data is a display data having a predetermined gray value.

11. The display driving method of claim 10, wherein the predetermined gray value is 0 or 255.

12. The display driving method of claim 10, wherein the predetermined gray value corresponds to a common voltage.

13. The display driving method of claim 8, wherein when the supply voltage is greater than a threshold value, the control signal corresponds to a first logic level; when the supply voltage is not greater than the threshold value, the control signal corresponds to a second logic level; when the control signal corresponds to the second logic level, outputting the auxiliary display data according to the control signal; and when the control signal corresponds to the first logic level, outputting the original display data according to the control signal.

14. The display driving method of claim 8, being applied in a liquid crystal display (LCD).
